(19) United States
(12) Patent Application Publication
(10) Pub. No.: US 2014/0266763 A1
(43) Pub. Date: Sep. 18, 2014

(54) ALTERNATIVE ENERGY PRODUCTION INDICATOR

(71) Applicant: Ross A. Abbey, Minneapolis, MN (US)

(72) Inventor: Ross A. Abbey, Minneapolis, MN (US)

(21) Appl. No.: 13/833,154

(22) Filed: Mar. 15, 2013

(51) Int. Cl. G08B 7/06

(52) U.S. Cl. CPC G08B 7/06
USPC 340/691.1

(57) ABSTRACT

An alternative energy production (AEP) apparatus can include an AEP device, and an AEP indicator coupled to the AEP device and configured to provide to an observer, an indication of an amount of energy produced by the AEP device.

### BACKGROUND

Numerous factors have contributed to an increased interest in clean, local, renewable energy sources. The adverse climate, health, and environmental impacts associated with the extraction, refinement, and combustion of fossil fuels are just a few examples of such factors. Other factors include rapidly growing global demand for renewable energy, the development of profitable renewable-energy industries and deployment models, and supply-chain participants operating at scale. For reasons related to national security, economic growth, and the finite nature of fossil-fuel resources, as well as for other reasons, national governments have sought to encourage renewable-energy development and deployment. Also, positive consumer interest, along with the fact that a rooftop renewable-energy installation can increase a property's resale potential, has contributed to growing demand for clean, local, renewable energy sources.

Several energy sources have emerged as viable alternatives to fossil fuels. Solar energy, for example, is a potentially attractive clean, renewable energy source. Solar energy can be harnessed via systems such as photovoltaic systems, and/or solar collector systems, among others. Similarly, hydrogen fuel cell systems and electrical battery cells have gained popularity as viable alternative energy sources for home and industrial use.

### BRIEF DESCRIPTION OF THE DRAWINGS

FIG. 1 is a block diagram illustrating an example of an apparatus in the form of an AEP system according to the present disclosure.

FIG. 2 illustrates an example of a photovoltaic panel.

FIG. 3 is a diagram illustrating an example of a portion of an apparatus in the form of an AEP system according to the present disclosure.

FIG. 4A is a layered view of an example wafer photovoltaic panel having an integrated AEP indicator according to the present disclosure.

FIG. 4B is a layered view of an example thin-film photovoltaic panel having an integrated AEP indicator according to the present disclosure.

### DETAILED DESCRIPTION

Examples of the present disclosure may include apparatuses and methods associated with alternative energy production (AEP) indicators. In accordance with a number of embodiments, an apparatus can include an AEP device and an AEP indicator coupled to the AEP device and configured to provide, to an observer, an indication of an amount of energy produced by the AEP device. An apparatus can also include an AEP system and a plurality of AEP indicators coupled to the AEP system and configured to provide, to an observer, an indication of at least one of: an amount of energy that is produced (e.g., generated) by the AEP system; and a production efficiency corresponding to the AEP system. As used herein, an apparatus can refer to a device, system, indicator and/or a support system. As used herein, energy refers to a usable form of energy (e.g., such as thermal energy captured in a thermal-transfer or thermal-storage medium, an electric potential measured in volts, an electric charge measured in coulombs, an electric current measured in amperes, electrical power measured in watts, electrical energy measured in kilowatt-hours, and/or an electric field measured in newtons per coulomb).

Unlike traditional energy production (TEP) devices, such as diesel generators or wind turbines, various AEP systems may not create noise or associated visible signals to indicate to an observer that the system is producing energy. Some AEP systems may use a light-emitting diode (LED) to indicate (e.g., via blinking) to a trained installer that the AEP system is functioning. However, such prior AEP systems fail to indicate to observers (e.g., owners, third party observers, untrained observers, etc.), who may be lay persons, whether energy is being produced by the AEP system, how much energy is being produced by the AEP system, and/or an efficiency of the AEP system. Furthermore, the LED associated with such AEP systems may not be visible to remote observers. Remote observers can be observers at a distance of 10 feet or more from the AEP system. However, embodiments are not so limited. In some examples, a remote observer can be an observer at a distance of 15 feet or 100 feet, for instance.

An efficiency of an AEP system can include a measure of light-conversion efficiency (e.g., energy conversion efficiency). The light-conversion efficiency can include a numerical metric indicating the ratio between the amount of incident sunlight reaching the AEP system and the amount of energy produced by the AEP system. In other examples, efficiency of an AEP system can include a measure of conversion loss (or gain). The conversion loss (or gain) can include a numerical metric indicating the amount of energy lost in converting direct current (DC) energy to alternating current (AC) energy.

AEP systems often vary with regard to the amount of energy they produce. For example, it is estimated that the average maximum capacity of energy production by a photovoltaic panel ranges from 180-230 watts. However, variable exposure to sunlight and/or the type of technology employed by photovoltaic panels can result in more or less energy produced than average. Absent some indication from the AEP system, observers are unaware whether the system is working (e.g., producing energy), how much energy the system is producing and/or a production efficiency associated with the AEP system.

Various TEP systems, such as those utilizing diesel generators, for example, generate exhaust as a waste byproduct, which can serve as an indicator to an observer that the TEP system is producing energy. Other TEP systems, such as those utilizing wind turbines, for example, can include blades that rotate about either a horizontal or a vertical axis, which can serve as an indicator that the TEP system is producing energy. However, with some AEP systems, such as photovoltaic systems and/or solar water heater systems, the absence of visual and/or audio indicators can prevent an observer from determining whether the AEP system is producing energy and/or how much energy the system is producing, for instance.

Some AEP systems may utilize a series of LEDs to indicate whether a solar chargeable battery is charged. However, such systems do not indicate the amount of energy being produced by the AEP system, may only indicate whether a battery is charged or not, and require trained observers to be near the AEP system (e.g., 10 feet or less away from the AEP system). Similarly, some previous photovoltaic systems activate a battery powered area illuminator at low ambient light intensities. However, such systems do not indicate whether and/or how much energy the AEP system is currently producing, and may activate the area illuminator when energy production is low or zero rather than when the system is producing energy.

In contrast, in accordance with a number of embodiments of the present disclosure, an AEP system can include an AEP indicator that provides an indication of the amount of energy produced by the AEP system. The AEP indicator can indicate to an observer, through direct observation of the AEP system itself (e.g., without the assistance of an external device such as a multimeter, an infrared sensor, a mobile computing device, and/or other device that is not directly and/or indirectly used to produce energy from an alternative energy source), that the AEP system is producing energy and/or how much energy is being produced by the AEP system, for instance. In a number of embodiments, the AEP indicator can be observed at a distance of at least 50 feet; however, embodiments are not so limited.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, “a number of” an element and/or feature can refer to one or more of such elements and/or features.

FIG. 1 is a block diagram illustrating an example of an apparatus in the form of an AEP system 100 according to the present disclosure. The AEP system 100 includes a number of interconnected AEP devices 102, 104, 106, 108, and 110. An AEP device can be a component of an AEP system that is used directly and/or indirectly to produce energy from an alternative energy source. For example, an AEP device (e.g., 102) can include a photovoltaic panel that can convert incident sunlight into an electrical current using the photovoltaic effect, a solar water heater that can capture incident solar energy in thermal form (e.g. and/or can concentrate incident sunlight to raise the temperature in a water storage tank), and/or other solar collector. In another example, an AEP device (e.g., 108) can include a power inverter that converts DC electricity to AC electricity. The AEP system 100 can include more or fewer AEP devices than those shown in FIG. 1.

The AEP system 100 includes an AEP indicator 112. The AEP indicator 112 can include a device which, upon direct observation of the AEP system 100 by an observer, can indicate (e.g., signal, display, symbolize, and/or announce) that the AEP system 100 is producing energy. For instance, an AEP indicator 112 can include a number of illuminating devices (e.g., LEDs, organic light emitting diodes (OLEDs), field-induced polymer electroluminescent lighting (FIPELs), fluorescent lights, and/or bio-luminescence) that emit visible light when the AEP system 100 is producing energy. In another example, an AEP indicator 112 can include a device producing an audible signal when the AEP system 100 is producing energy. However, examples are not so limited, and the AEP indicator 112 can include various devices capable of indicating that the AEP system 100 is producing energy as discussed further herein. In a number of examples, the AEP indicator 112 can be observed by a remote observer (e.g., from a distance of greater than 10 feet from the AEP system 100).

As an example, AEP indicator 112 can play music and/or some other type of audible signal when AEP device (e.g., 102 to 110) is producing energy. For instance, instructions stored on a computer readable medium can be executed (e.g., by a processor) to play a user configurable music and/or audio file when a number of photovoltaic panels are producing energy. In some such example, the user configurable music and/or audio file could cease to play when the number of photovoltaic panels ceased producing energy.

In a number of examples, the AEP indicator 112 can provide to an observer an indication of the amount of energy being produced by the AEP system 100. For example, the AEP indicator 112 can include a number of illuminating devices (e.g., LEDs) that emit visible light of a particular frequency and/or intensity based on the amount of energy being produced. For instance, the amount of LEDs emitting visible light and/or the color of light emitted may vary depending on the amount of energy being produced. As an example, the frequency and/or intensity of the light emitted by an AEP indicator 112 can be based on a maximum energy production capacity of AEP system 100. For instance, if the maximum energy production capacity of the AEP system 100 is 230 watts, the system can be configured such that LEDs corresponding to AEP indicator 112 emit a maximum amount of visible light when the AEP system 100 is producing 230 watts of energy. Conversely, the AEP system 100 can be configured such that LEDs corresponding to AEP indicator 112 emit 85% of the maximum amount of visible light when the AEP system 100 is producing 195 watts of energy (e.g., 85% of the maximum energy production capacity) and no visible light when the AEP system 100 is producing 0 watts of energy. In some examples, the AEP system 100 can produce an increased amount of illumination in response to an increase in incident sunlight (e.g., AEP system 100 can emit a greater amount of visible light during daylight hours and/or when incident sunlight is unobstructed by clouds and/or other objects that may decrease incident sunlight).

In a number of examples, the AEP indicator 112 can emit visible light when the AEP system 100 is not producing energy. For example, AEP indicator 112 can display a distinct pattern and/or color of visible light as an error indicator, such as when the AEP system 100 is not functioning properly (e.g., broken). For instance, the AEP system 100 can include a number of interconnected photovoltaic panels and can include an AEP indicator 112 that displays a first color (e.g., green) when the photovoltaic panels are producing energy and displays a second color (e.g., red) when one or more of the interconnected photovoltaic panels are broken. In another instance, the AEP system 100 can include a number of interconnected photovoltaic panels and can include an AEP indicator 112 that displays a distinct light pattern when one or more of the interconnected photovoltaic panels are broken. In this example, a distinct light pattern can include a repetitive sequence of light activation and deactivation and/or a randomized sequence of light activation and deactivation. Embodiments are not so limited, however, and the AEP indicator 112 can display light when a variety of components of the AEP system 100 are not functioning properly.

FIG. 2 illustrates an example of a photovoltaic panel 202. In a number of examples, an AEP device (e.g., 102 to 110) can include a number of photovoltaic panels 202. An AEP system 100 can include a plurality of interconnected photovoltaic panels 202. As shown in FIG. 2, each of the interconnected photovoltaic panels 202 can include a plurality of structural and electrical units referred to as photovoltaic modules 203. Each photovoltaic module 203 can include a plurality of photovoltaic cells 201 (e.g., solar cells) that can convert sunlight directly into a usable form of energy (e.g., electricity).

In a number of examples, the photovoltaic panel 202 can include a rigid structure including photovoltaic cells 201 comprised, at least in part, of wafers of light absorbing materials (e.g., a wafer photovoltaic panel). For instance, photovoltaic cell 201 can include a wafer comprising, at least in part, a number of materials (e.g., layers) such as a superstrate material (e.g., glass), an antireflective material, a front contact material, a photovoltaic material, a back contact material, and/or a metal backing material. Example photovoltaic materials can include crystalline silicon, monocrystalline silicon, polycrystallinen silicon, amorphous silicon, cadmium telluride, copper indium selenide, and/or various other materials and/or combinations thereof capable of converting sunlight into a usable form of energy.

In a number of examples, the photovoltaic panel 202 can include a thin-film structure including photovoltaic cells 201 comprised of light absorbing materials which may be less than 350 microns thick (e.g., a thin-film photovoltaic panel), for instance. As an example, photovoltaic cell 201 can comprise a number of materials (e.g., material layers) such as a superstrate material (e.g., glass), a transparent adhesive material, an antireflective material, a photovoltaic material, and/or combinations thereof. In a number of examples, the photovoltaic material can include a number of semiconductor materials such as amorphous silicon, cadmium telluride, copper indium gallium deselenide and/or combinations thereof. However, embodiments are not so limited. For instance, the photovoltaic material can include various other semiconductors and/or non-semiconductor materials.

FIG. 3 is a diagram illustrating an example of a portion of an apparatus in the form of an AEP system 300 according to the present disclosure. As shown in FIG. 1, an AEP device and an AEP indicator can be independent from one another (e.g., not connected on the same device and/or structural unit). However, in a number of examples, the AEP indicator can be integrated with the AEP device (e.g., contained on and/or in the AEP device). For example, an AEP device can include a wafer photovoltaic panel 302. The AEP indicator can include an illumination strip 312. The illumination strip 312 can be integrated with the wafer photovoltaic panel 302 by surrounding the perimeter of the wafer photovoltaic panel 302 with the illumination strip 312 (e.g., perimeter illumination), and laying a substrate 307 (e.g., glass) over the wafer photovoltaic panel 302 and the illumination strip 312, for instance. The illumination strip 312 can include, for example, a number of illumination devices (e.g., LEDs) arranged around the perimeter of the wafer photovoltaic panel 302. The number of LEDs can include a flexible LED light strip, an LED ribbon light strip, and/or individual LEDs. However, examples are not so limited. For example, the illumination strip 312 can include other illumination devices capable of emitting visible light.

In a number of examples, the illumination strip 312 can emit a particular intensity of light. For example, the illumination strip 312 may emit visible light only when the AEP system 300 produces energy above a threshold level, which may be a threshold percentage of maximum energy production capacity (e.g., in a binary mode). For instance, if the AEP system 300 has a maximum energy production capacity of 200 watts, the illumination strip 312 can emit visible light so long as the AEP system 300 produces at least 50 watts of energy, or 25% of the maximum energy production capacity. When the AEP system 300 no longer produces energy above the threshold, the illumination strip 312 does not emit visible light, in this example.

In other examples, the illumination strip 312 can emit light in a continuum of luminance (e.g., luminous intensity per unit area) proportionate to the amount of energy produced by the AEP system 300. For example, if the AEP system 300 produces energy at a low end of the maximum energy production capacity (e.g., 10 watts), the illumination strip 312 can emit light at a low end of the continuum of luminance (e.g., 50 cd/m²). Conversely, if the AEP system 300 produces energy at a high end of the maximum energy production capacity (e.g., 200 watts), the illumination strip 312 can emit light at a high end of the continuum of luminance (e.g., 300 cd/m²).

In yet another example, the illumination strip 312 can emit light at a number of different levels of luminance, based on the amount of energy produced by the AEP system 300. For example, threshold levels of luminance can be established corresponding to threshold levels of energy production capacity for the AEP system 300 (e.g., 10%, 20%, 30%, etc. of maximum energy production capacity). The level of luminance can increase when each threshold level of energy production capacity is exceeded. Conversely, the level of luminance can decrease when the threshold level of energy production capacity is no longer exceeded.

The illumination strip 312 can also emit different colors of visible light, based on the amount of energy produced by the AEP system 300. For example, the illumination strip 312 can emit a first color (e.g., red) when energy production by the AEP system 300 is above a first threshold level of energy production (e.g., low production), a second color (e.g., yellow) when energy production by the AEP system 300 is above a second threshold level of energy production (e.g., medium production), and a third color (e.g., green) when energy production by the AEP system 300 is above a third threshold level of energy production (e.g., high production).

In a number of examples, the illumination strip 312 can emit light based on a time-weighted average of energy produced by the AEP system 300. For example, instructions stored on a computer readable medium can be executed (e.g., by a processor) to calculate an average amount of energy produced by the AEP system 300 over time. As the time-weighted average of energy produced increases, the luminance of the illumination strip 312 can increase.

In a number of examples, the illumination strip 312 can emit light based on an area-weighted average of energy produced by the AEP system 300. For example, instructions stored on a computer readable medium can be executed (e.g., by a processor) to calculate an average amount of energy produced by the AEP system 300 at a particular point in time. For instance, an area-weighted average can be calculated for an AEP system 300 including 10 photovoltaic panels, wherein 3 of the 10 panels receive a greater amount of incident sunlight, such that the illumination strip 312 can emit light based on the area-weighted average of energy produced by all 10 photovoltaic panels (e.g., calculate an average amount of energy produced by a plurality of photovoltaic panels). Alternatively, and/or in addition, each AEP device comprising the AEP system 300 (e.g., via an illumination strip 312) can emit light based on the amount of energy produced by that particular AEP device. Embodiments of the present disclosure are not limited to the above examples. As mentioned herein, an AEP indicator can include various numbers of devices capable of emitting visible light, such as LEDs and/or OLEDs. In a number of examples, the AEP indicator can include an active illumination device (e.g., one requiring an electric current). Such active illumination devices can decrease the efficiency of the AEP system because a portion of the electrical current produced by the AEP system can be used to produce visible light. However, embodiments are not so limited, and the AEP indicator can use an electrical current originating outside the AEP system (e.g., integrated battery system) to produce visible light.

In other examples, the AEP indicator can include a passive illumination device (e.g., one requiring no electric current). For example, small-scale devices can be used to reflect, concentrate, scatter, and/or redirect incident sunlight to produce visible light. For instance, referring to FIG. 3, the AEP indicator can include a passive illumination device such as an optical surface 312 (e.g., a fiber optics surface). The optical surface 312 can include a surface covered (e.g., painted) with a material (e.g., liquid) containing fiber optic segments oriented either directionally (e.g., in a particular direction) or randomly to produce visible light. The optical surface 312 can also include a surface of fused (e.g., woven) fiber optic segments directionally aligned in one or more directions to produce visible light. For example, optical surface 312 can include a painted and/or applied surface of micro- or nano-scale structures, for instance, that manipulate incident sunlight into displaying visible light in an aura-like effect (e.g., a circle of light, a ring of light, a halo of light, and/or a glow).

In a number of examples, the AEP indicator can display visible light in a manner that adds to the aesthetic qualities of the AEP system (e.g., displays visible light in a manner that adds marketable value to the AEP system). For instance, the AEP indicator can display a number of different colors and/or patterns of colors that function as decoration, ornamentation, and/or embellishment. For instance, the AEP indicator can play audio music.

FIG. 4A is a layered view of an example photovoltaic panel 402-1 having an integrated AEP indicator 412 according to the present disclosure. The photovoltaic panel 402-1 (e.g., a wafer photovoltaic panel 402-1) includes a number of materials (e.g., layers) and integrates the AEP indicator 412. For example, the photovoltaic panel 402-1 can include a superstrate material 407 (e.g., glass), AEP indicator 412, an anti-reflective material 409, a front contact material 417, a photovoltaic material 413, a back contact material 419, and/or a back sheet material 421. The photovoltaic material 413 can comprise a number of materials including crystalline silicone, monocrystalline silicon, polycrystallinen silicon, amorphous silicon, cadmium telluride, copper indium selenide, and/or combinations thereof, among various other materials capable of converting sunlight into a usable form of energy.

The AEP indicator 412 can include a transparent material that permits incident sunlight 425 to pass through to the photovoltaic material 413. However, in a number of examples, the AEP indicator 412 can include a material that is at least partially opaque (e.g., at least partially reduces the amount of incident sunlight 425 that passes through to the photovoltaic material 413). As discussed herein, the AEP indicator 412 can emit light in proportion to the amount of energy produced by the AEP device 402, for example.

FIG. 4B is a cross-sectional view of an example photovoltaic panel 402-2 having an integrated AEP indicator 412 according to the present disclosure. The photovoltaic panel 402-2 (e.g., a thin-film photovoltaic panel) includes a number of materials and integrates the AEP indicator 412. For example, the photovoltaic panel 402-2 can include a superstrate material 407 (e.g., glass), a transparent adhesive material 423, the AEP indicator 412, an anti-reflective material 409, and/or the photovoltaic material 413, comprising, an electrode material 413-1, an n-type semiconductor material 413-2, a p-n junction material 413-3, a p-type semiconductor material 413-4, an electrode material 413-5, and/or a substrate material 413-6.

In a number of examples, the n-type semiconductor material 413-2 can include a semiconductor material mixed with phosphorus and can develop an excess of free electrons. The p-type semiconductor material 413-3 can include a semiconductor material mixed with boron and can develop excess holes that accept electrons. The p-n junction material 413-3 can include a material that allows a number of electrons to move between the p-type semiconductor material 413-3 and the n-type semiconductor material 413-2. As the amount of energy produced by the AEP device 402-2 increases, the amount of visible light emitted by the AEP indicator 412 can increase. Conversely, as the amount of energy produced by the AEP device 402-2 decreases, the amount of visible light emitted by the AEP indicator 412 can decrease. However, embodiments are not so limited. For instance, the AEP indicator 412 can display a variety of different visual signals (e.g., a particular color, a particular pattern of light, a particular intensity of light) to indicate whether and/or how much energy the AEP device 402-2 is currently producing.

In other examples, the AEP indicator 412 can be integrated into the surface of a pre-existing AEP system (e.g., an after-market installation). For instance, if the AEP system is purchased without an AEP indicator 412, the AEP indicator 412 can be attached to the top of the AEP system such that incident sunlight 425 contacts the AEP indicator 412 first (e.g., before any other material layer of the AEP system). In such examples, the AEP indicator 412 can be removed from the AEP system and/or replaced as needed. In a number of such examples, the manufacturing costs for an AEP system integrating an AEP indicator 412 (e.g., as a newly manufactured AEP system or as an after-market installation) can increase relative to the manufacturing costs for an AEP system without an AEP indicator 412.

A number of different methods can be employed to integrate an AEP indicator into an AEP apparatus. While the foregoing examples describe the AEP indicator being integrated into the surface of an AEP device, being integrated into the perimeter of the AEP device, or being integrated inside the body of the AEP device, examples are not so limited. In a number of examples, the AEP indicator can be integrated into a structure supporting the AEP device and/or system (example not illustrated). For example, an AEP system can include a number of AEP devices (e.g., a solar water heater, and/or a wafer photovoltaic panel) that are fixed to a structure with a support system, such as a metal rack. The AEP indicator can be integrated into the support system and/or can be coupled to the AEP system such that the AEP indicator displays on the support system (e.g., an observer can observe the AEP indicator by direct observation of the support system), the amount of energy currently being produced by the AEP system. Alternatively and/or in addition, the AEP indicator 412 can be coupled to the support system as an after-market installation (e.g., the AEP indicator 412 can be coupled to the support system of an existing AEP system).

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. An apparatus, comprising:
an alternative energy production (AEP) device; and
an AEP indicator coupled to the AEP device and configured to provide, to an observer, an indication of an amount of energy produced by the AEP device.

2. The apparatus of claim 1, wherein the AEP indicator is configured to provide to an observer an indication of production efficiency corresponding to the AEP device.

3. The apparatus of claim 1, wherein the AEP indicator is a visual indicator.

4. The apparatus of claim 1, wherein the AEP indicator is an audio indicator.

5. The apparatus of claim 1, wherein the AEP indicator is configured to emit fight in a continuum of luminance proportionate to the amount of energy that is produced by the AEP device.

6. The apparatus of claim 1, wherein the AEP indicator is configured to emit light at a number of different levels of luminance based on the amount of energy that is produced by the AEP device.

7. The apparatus of claim 1, wherein the AEP device comprises a number of material layers, and wherein the AEP indicator comprises at least one of the number of material layers.

8. The apparatus of claim 1, wherein the AEP indicator is coupled to a support system supporting the AEP device.

9. The apparatus of claim 1, wherein the AEP indicator is a visual indicator visible to the observer at a distance of at least 25 feet.

10. An apparatus, comprising:
an alternative energy production (AEP) system; and
a plurality of AEP indicators coupled to the AEP system and configured to provide, to an observer, an indication of at least one of:
whether the AEP system is producing energy; and
an amount of energy produced by the AEP system.

11. The apparatus of claim 10, wherein the plurality of AEP indicators are configured to provide, to an observer, an indication of a production efficiency corresponding to the AEP system.

12. The apparatus of claim 10, wherein the plurality of AEP indicators are configured to emit light based on a time-weighted average of energy produced by the AEP system.

13. The apparatus of claim 10, wherein the AEP system comprises a number of photovoltaic panels.

14. The apparatus of claim 13, wherein the AEP indicators are integrated into a surface of the number of photovoltaic panels.

15. The apparatus of claim 13, wherein the AEP indicators are integrated only into a perimeter of the number of photovoltaic panels.

16. An apparatus, comprising:
an alternative energy production (AEP) system comprising a number of AEP devices; and
a number of AEP indicators coupled to the number of AEP devices, wherein:
the number of AEP devices each comprise a number of material layers;
the number of AEP indicators are integrated into at least one of the number of material layers; and
the number of AEP indicators are configured to provide, to an observer, an indication of an amount of energy that is produced by the AEP system.

17. The apparatus of claim 16, wherein the number of AEP indicators are configured to provide, to an observer, an indication of a light-conversion efficiency corresponding to the AEP system.

18. The apparatus of claim 16, wherein the number of AEP devices are thin-film photovoltaic panels.

19. The apparatus of claim 16, wherein the number of AEP indicators include a surface fused with fiber optic segments directionally aligned to produce visible light.

20. The apparatus of claim 16, wherein the number of AEP indicators include a number of light-emitting diodes.
